(19) United States
(12) Patent Application Publication
(10) Pub. No.: US 2011/0158163 A1
(43) Pub. Date: Jun. 30, 2011

(54) ENERGY EFFICIENT INTEGRATED ROUTING PROTOCOL

(75) Inventors: Sankhyan CHOUDHURY, Kolkata (IN); Rakesh Kumar Mishra, Kolkata (IN); Nabendu Chaki, Kolkata (IN)

(73) Assignee: UNIVERSITY OF CALCUTTA, Kolkata (IN)

(21) Appl. No.: 12/717,134

(22) Filed: Mar. 4, 2010

(30) Foreign Application Priority Data
Dec. 28, 2009 (IN) 1476/KOL/2009

(51) Int. Cl. H04W 40/00

(52) U.S. Cl. 370/328

(57) ABSTRACT

A Link Layer (e.g., TCP/IP Layer 1, OSI Layer 2) routing protocol that routes frames from a sending node to a receiving node based upon service solicitation and availability is proposed. The routing protocol may reduce control messages across the layers, and may achieve greater energy efficiency by placing non-participating nodes into a sleep mode for durations of time while an ad hoc network is being utilized by participating nodes. The proposed scheme may also reduce network setup time by enabling routing as soon as a service and corresponding request is initiated.

### CROSS-REFERENCE TO RELATED APPLICATIONS

The present application claims the benefit of Indian Patent Application No. 1476/KOL/2009, filed Dec. 28, 2009, which is hereby incorporated by reference in its entirety.

### BACKGROUND

Ad hoc networks are decentralized wireless networks which do not rely on a pre-existing infrastructure, such as access points or dedicated routers, but instead utilize each node in forwarding data for other nodes. “For-the-purpose” networks are ad-hoc networks that are formed by a group of nodes utilizing their own wireless interfaces for collaborative tasks. These networks are generally formed when an infrastructure network is either unreliable or non-existent, and therefore are usually short lived and self-centric. By self-centric, it is implied that the node within the network may be disinterested in communication outside the network, for example with the internet. “For-the-purpose” networks may be established for conferences, exhibitions or any other such places. Such networks may or may not have a large number of participating nodes. Typically all nodes may be confined within certain predefined geographical limits. Furthermore, the nodes may be executing a predefined set of services, such as application support and communication services.

One desire for “for-the-purpose” networks is quick employability to decrease the time required to start communication between nodes. This suggests reducing both network start-up time and the time for formulating a logical distribution infrastructure. In this regard, network start-up time mainly refers to topology awareness before commencement of transmission within a single hop, while logical distribution infrastructure implies the formation of a tree or mesh for distribution of data. These two activities are among the most energy and bandwidth consuming activities on the network, which can influence network performance greatly.

The IEEE 802.11 standard, broadly used for wireless networking today, is designed to support both infrastructure and ad-hoc wireless networks. IEEE 802.11 coordinates a plurality of nodes' access of the wireless medium through a Distributed Coordination Function (DCF) that is based on a distributed, contention based carrier sensing with collision avoidance (Carrier Sense Multiple Access with Collision Avoidance, or CSMA/CA) Media Access Control (MAC) protocol. Under this protocol, a node wishing to transmit must listen for the channel status during an interval of time called the DCF Inter-Frame Space (DIFS), wherein frames are digital data transmission units. If the channel is found to be busy during the DIFS interval, the sending node may defer its transmission. Control frames of IEEE 802.11 have a duration field which is used to set the Network Allocation Vector (NAV) within the node to identify the time period after which the node enters into a contention phase. If a channel is found to be idle for DIFS, the sending node is free to take control of the wireless medium, and does so by raising a Request to Send (RTS) frame. The receiving node waits for the Small Inter-Frame Space (SIFS) duration, after which it sends a Clear to Send (CTS) frame. Subsequently the sending node sends a DATA frame which the receiving node replies to with an Acknowledgement (ACK) frame, both of which are separated by the SIFS duration. This protocol enables peer-to-peer unicast communication between one-hop neighbors.

It is convenient to characterize the control and transmission of data over a network using the concept of layers. In these characterizations, a network and what is transmitted over it are divided into separate abstraction layers, where each layer is a collection of similar functions that serve the layer above it, and receives service from the layer below it.

One model, the Transmission Control Protocol/Internet Protocol (TCP/IP) reference model, abstracts network functions into four layers. TCP/IP Layer 1, the Link Layer, provides the ability to transfer data by managing the delivery of frames through the use of physical addressing. TCP/IP Layer 2, the Network Layer, manages the routing function by maintaining end to end connection from source to target machines using the routing functions. TCP/IP Layer 3, the Transport Layer, provides the inter-process communication, error correction, and other functions, such as reliability management. TCP/IP Layer 4, or the Application Layer, interacts directly with a software application, and determines the identity and availability of communication partners for an application with data to transmit to.

Under another model, the Open System Interconnection Reference Model (OSI Model), layered communications are abstracted into seven layers. OSI Layer 2, the Data Link layer, is broadly analogous to TCP/IP Layer 1 in that it manages the delivery of data transfers between network entities through physical addressing. OSI Layer 3, the Network Layer, is analogous to the Network Layer of TCP/IP Layer 2. Additional models, both presently existing, or developed in the future, may also be used to characterize network interactivity, however the nomenclature is unimportant, and focus should remain instead on the roles taken by the layers.

Currently, routing issues for ad-hoc networks are typically controlled from the Network Layer, TCP/IP Layer 2 (OSI Layer 3). Routing and related issues from this layer and above contribute considerable control traffic towards TCP/IP Layer 1, the Link Layer (OSI Layer 2, the Data Link Layer). Moreover, the transmission is essentially uni-casting in nature. To support multicasting and broadcasting, additional provisions should be made and maintained throughout the life of the network.

Services, another essential component of a network, represent the functionality a network can perform, and typically remain at the core of network operations. Currently the service related issues for ad-hoc networks are addressed at application layer. Service-related provisions also contribute towards control traffic, creating considerable control overhead at TCP/IP Layer 1 (OSI Layer 2), and presenting a high cost for bandwidth scarce “for-the-purpose” networks.

### BRIEF DESCRIPTION OF THE DRAWINGS

Features of the invention are shown in the drawings, in which like reference numerals designate like elements. The drawings form part of this original disclosure in which:

FIG. 1 is an example illustration of an embodiment of a routing mechanism (method) from the perspective of a sending node;

FIG. 2 is an example illustration of an embodiment of a routing mechanism (method) from the perspective of a receiving node;

FIG. 3 is a transition diagram illustrating an embodiment's sending state;

FIG. 4 is a transition diagram illustrating an embodiment's receiving state;

FIG. 5 is a table depicting an embodiment's modifications to wireless network control frames;

FIG. 6 is an example illustration of a system for network communications;

FIG. 7 is an example illustration of a system for network communications; and,

FIG. 8 is an example illustration of a system for network communications.

### DETAILED DESCRIPTION

In the description which follows, a number of terms are used. Terms may be defined as follows:

Node. Any device that may interact on a network, including but not limited to a computer, a handheld device, a mobile device, a netbook, a smart phone, mobile internet device, and so on.

Sending node. A node that is in a state that wishes to transmit data.

Listening node. Any node that is in a 1-hop vicinity of a sending node.

Participating node. Any node that determines, based on a service code transmitted by a sending node, that it wishes to participate in communication with the sending node.

Non-participating node. Any node that determines, based on a service code transmitted by a sending node, that it does not wish to participate in communication with a sending node.

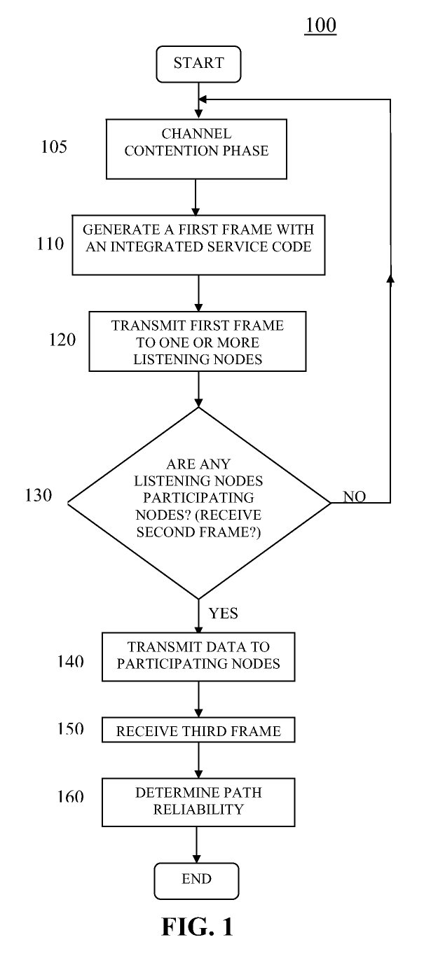

Referring to FIG. 1, in an embodiment of a method 100 at step 105, the nodes may contend for a channel, using a process such as CSMA/CA, and proceed when the channel is found free. At step 110, a first frame with an integrated service code is generated. The first frame may be in accordance with any number of routing protocols, including but not limited to any of the IEEE 802.11 specification protocols, such as 802.11a, 802.11b, 802.11 g, and 802.11n. In some embodiments, as illustrated in FIG. 5, the first frame may be an Integrated Request to Send (IRTS) frame 510. In some embodiments, the IRTS frame may comprise an 802.11 RTS frame 515, which may maintain backwards compatibility with IEEE 802.11. In some embodiments, the frame may also have an integrated frame sequence number, which can differentiate packets of data in the same transmission, or be used to determine whether a transmission was received correctly. Such a frame may be useful in avoiding routing loops by maintaining uniquely identified data packets.

The service code may be of any suitable type or configuration, including but not limited to a number comprising a node identifier and a unique identification number for a service. As a non-limiting example, in some embodiments the service code could be 64 bits long, wherein the first 48 bits would identify a node within a network, while the remaining 16 bits could define the services extended by the node. The node identifier can be any suitable identifying number, including but not limited to the node's identification number, for example, the node's MAC ID number. In an embodiment, a service may be known over a network by the service code. In an embodiment, nodes may store service codes in a code table. In an embodiment, the code table may be periodically refreshed across the nodes. In an embodiment, there may be a default initial set of services. Some default services may perform basic network maintenance and operation management, including but not limited to topology assessment, and code table initialization.

Once the first frame has been generated, the sending node may have to wait until the network channel is free to transmit the frame. Returning to FIG. 1, the signaling process can be seen in step 120, which calls for transmitting the first frame, such as an IRTS frame, from a sending node to one or more listening nodes. The transmission itself may be over any form of wireless transmitter, including but not limited to the 802.11 standard devices, Bluetooth, and nonstandard proprietary transmitters. The transmission may use any suitable frequency band, including but not limited to the 2.4 GHz Industrial, Scientific, and Medical (ISM) Band, and the 5 GHZ Unlicensed National Information Infrastructure (U-NII) band.

As seen in step 130, once the first frame has been transmitted from the sending node to the listening nodes, the sending node determines if at least one of the one or more listening nodes has determined that it is a participating node. In some embodiments, the sending node's determination process comprises receiving a second frame from each participating node. The second frame may be in accordance with any number of routing protocols, including but not limited to any of the IEEE 802.11 specification protocols, such as 802.11a, 802.11b, 802.11 g, and 802.11n. In some embodiments, as illustrated in FIG. 5, the second frame may be an Integrated Clear to Send (ICTS) frame 520, comprising the receiving node's identification number including but not limited to the node's MAC ID number. In some embodiments, the ICTS frame may comprise an 802.11 CTS frame 525, which may maintain backwards compatibility with IEEE 802.11. In some embodiments, the ICTS frame 520 may also contain a frame sequence number, which can differentiate packets of data in the same transmission, or be used to determine whether a transmission was received correctly. This can be useful in avoiding routing loops by maintaining uniquely identified data packets.

If there are no participating nodes, then there are no nodes to which data may be transferred. In an embodiment, if no ICTS frames are received by the sending node within a predetermined interval of time, the sending node may mark the transmission accordingly, and may resume with other transmissions on queue. Returning to FIG. 1, if there is at least one participating node, however, then the sending node may transmit a piece of data from the sending node to the participating nodes (140).

In some embodiments where at least one listening node is a participating node, determining if any listening nodes are participating nodes comprises receiving a second frame from the participating nodes. The method 100 may further comprise receiving a third frame from the participating nodes. In some embodiments, method 100 may further comprise determining path reliability from the third frame (160). This may be done by any suitable means, including but not limited to comparing the third frame and the second frame to analyze deviation in their existence or content.

The third frame may be in accordance with any number of routing protocols, including but not limited to any of the IEEE 802.11 specification protocols, such as 802.11a, 802.11b, 802.11 g, and 802.11n. In some embodiments, as illustrated in FIG. 5, the third frame may be an Integrated Acknowledgement (IACK) frame 530, comprising the receiving node's MAC ID number. In some embodiments, the IACK frame may comprise an 802.11 ACK frame 535, which may maintain backwards compatibility with IEEE 802.11. In some embodiments, the IACK frame 530 may also contain a frame sequence number, which can differentiate packets of data in the same transmission, or be used to determine whether a transmission was received correctly. As an example, in an embodiment if a sending node in a previous transmission does not receive the third frame (such as an IACK frame) from all participating nodes, then it may try to retransmit the piece of data for participating nodes that raised the second frame (such as an ICTS frame), but did not successfully transmit the third frame to the sending node within a specified time. In an embodiment, the participating node may adopt a suitable strategy for power saving by differentiating between current and retransmitted frames, based on the frame sequence number.

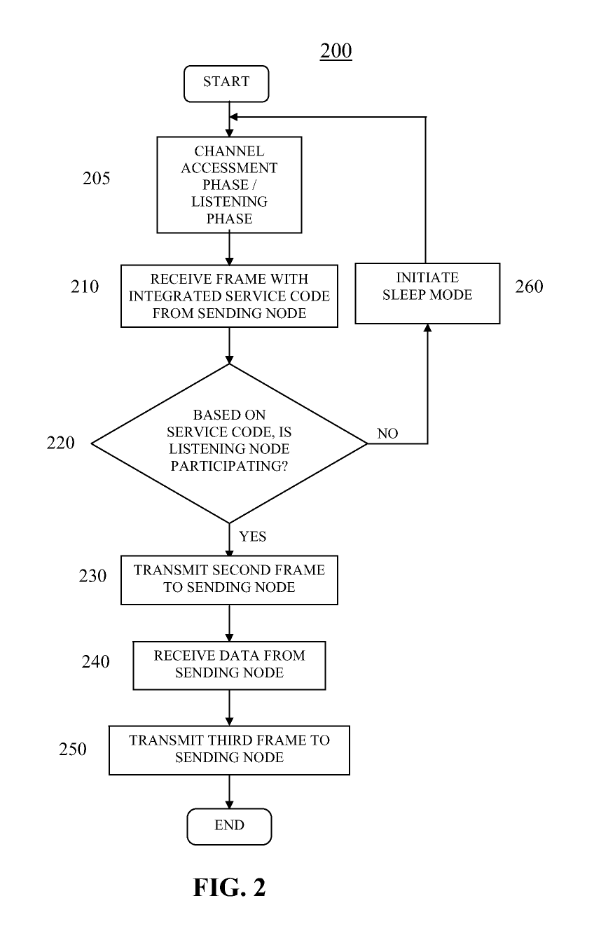

FIG. 2 illustrates a method 200 for performing routing over a network. One or more listening nodes may initially perform channel assessment 205 to assess the channel state and listen for any on going transmissions. At step 210, the one or more listening nodes receive a first frame comprising an integrated service code. The first frame may conform to any number of routing protocols, including but not limited to any of the IEEE 802.11 specification protocols, such as 802.11a, 802.11b, 802.11 g, and 802.11n. In some embodiments, as illustrated in FIG. 5, the first frame may be an IRTS frame 510. In some embodiments the frame could also have an integrated frame sequence number, which can differentiate packets of data in the same transmission, or be used to determine whether a transmission was received correctly. Such a frame may be useful in avoiding routing loops by maintaining uniquely identified data packets. In an embodiment, the listening node may be in an idle state when it receives the frame.

Returning to FIG. 2, the illustrated method 200 further comprises step 220, in which one or more listening nodes determine, based on the integrated service code, if the listening nodes are participating nodes. This determination may be made by any suitable means, including but not limited to comparing the service code with an internal list of approved service codes, or verifying that the service code is not on a list of banned service codes. In an embodiment, a listening node may determine that it is a participating node if it is an intermediate router for next hop neighbors.

If based on the service code a listening node is a participating node, the participating node may then proceed to step 230, where it may transmit a second frame. The second frame may be in accordance with any number of routing protocols, including but not limited to any of the IEEE 802.11 specification protocols, such as 802.11a, 802.11b, 802.11 g, and 802.11n. In some embodiments, as illustrated in FIG. 5, the second frame may be an ICTS frame 520. The second frame may comprise the participating node's identification number including but not limited to the node's MAC ID number. In some embodiments, the ICTS frame 520 may also contain a frame sequence number, which can differentiate packets of data in the same transmission, again useful in avoiding routing loops by maintaining uniquely identified data packets, or be used to determine whether a transmission was received correctly.

Returning to the embodiment of FIG. 2, as shown in step 240, the participating node may then receive a piece of data from the sending node. In some embodiments, as seen in step 250, the method may further comprise transmitting a third frame from the participating nodes to the sending node. This third frame may be in accordance with any number of routing protocols, including but not limited to any of the IEEE 802.11 specification protocols, such as 802.11a, 802.11b, 802.11 g, and 802.11n. In some embodiments, as illustrated in FIG. 5, the third frame may be an IACK frame 530. The third frame may comprise the receiving node's identification number including but not limited to the node's MAC ID number. In some embodiments, the IACK frame 530 may also contain a frame sequence number, which can differentiate packets of data in the same transmission, or be used to determine whether a transmission was received correctly. In some embodiments, the participating node may enter an idle state following transmission of the third frame.

As seen in step 260 of the embodiment of method 200 in FIG. 2, some embodiments may further comprise initiating a sleep mode on the listening nodes that are not participating nodes. This sleep mode may be initiated in any suitable way, including, but not limited to, updating the NAV value of the non-participating node, disabling power to the wireless transmitter, entering a reduced power mode, and so on. The duration of the sleep mode may be of any defined time interval, including but not limited to a calculated time wherein the non-participating nodes may awake when the sending nodes and the participating nodes have completed their transmissions. After this, the method may return back to step 205.

In an embodiment, this duration includes the time required for any participating nodes to transmit the first frame (which may include the integrated service code), the second frame, the piece of data, and the third frame. As a non-limiting example, in embodiments where the frames are respectively IRTS, ICTS, and IACK, the duration of the sleep mode may be a time t₁, wherein t₁=(T_{IRTS}+SIFS+N*T_{ICTS(N)}+α*SIFS+T_{DATA}+N*T_{IACK(N)})−β*T_{IACK}. Within the calculation of such an embodiment, T values are the time to transmit each frame or piece of data, SIFS is the time of the Small Inter-Frame Space (the time between a data frame and an acknowledgement), N is the number of nodes transmitting the respective frames, and α and β are appropriate constants. In an embodiment, any values of α and β may be used which provide sufficient time for contention and confirmation. In various embodiments, the value of the constant α may be selected to provide time for retransmission of collided ICTS frames that may occur in spite of the common contention process. In some embodiments, the value of β may be chosen such that all non-participating nodes awaken from their sleep modes prior to a subsequent transmission, which may ensure that all nodes have the opportunity to access the medium, and are not habitually asleep when the medium is free for transmission. In an embodiment, β may be selected to provide a fractional time of T_{IACK}. In some embodiments, α and β are approximately 3 and 0.5 respectively. In other embodiments, other values for α and β may of course be used. In some embodiments, after sleeping the node may proceed back to channel assessment (step 205), and take part in communication afresh.

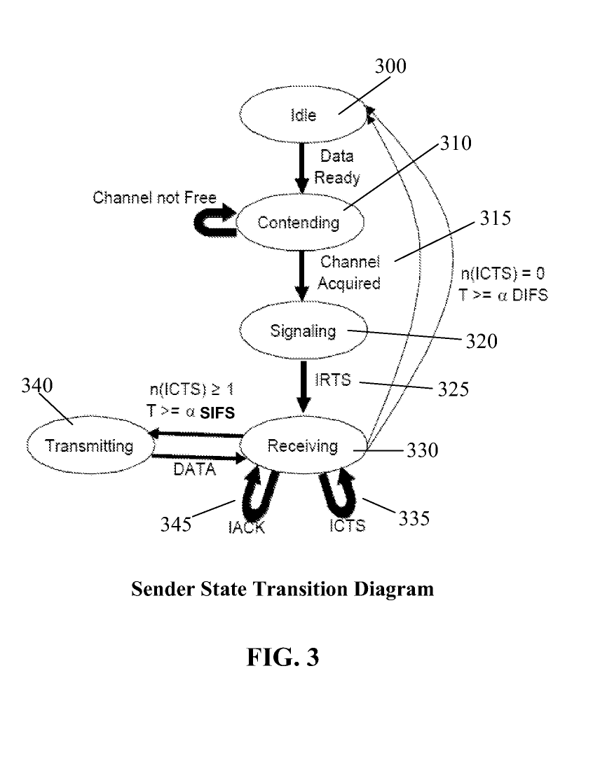

In an embodiment illustrated in FIG. 3, the sending node may move from an idle state 300 to enter a contending loop 310, where it waits until a channel is acquired 315, and the node is free to begin signaling 320. In the illustrated embodiment, signaling 320 comprises transmitting a first frame 325, such as an IRTS frame. After transmitting the first frame 325, the sending node enters a receiving state 330, where it waits to receive a second frame 335, such as an ICTS frame from any participating nodes. The duration by which the sending node waits after receiving the second frame may be any suitable time, including but not limited to a time that is greater than or equal to a integer multiple of the SIFS interval. If the number of second frames, such as ICTS frames, received by the sending node equals zero, represented in FIG. 3 as n(ICTS)=0, then the sending node may presume that there are no participating nodes, and may return to the idle state 300, where it may wait before attempting to send or receive its next transmission. If the number of second frames received by the sending node is greater than or equal to one, represented in the illustrated embodiment as n(ICTS)≧1, then the sending node is free to begin transmitting data 340. In an embodiment, after transmitting data, the sending node may wait to receive a third frame 345, represented in the illustrated embodiment as an IACK frame, which it may use to determine path reliability.

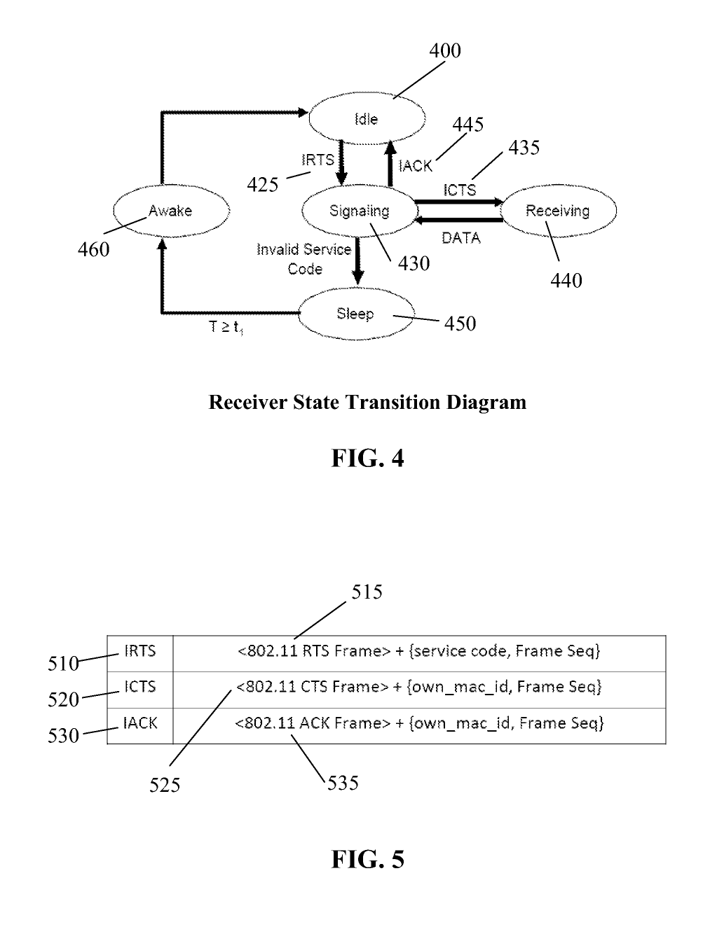

In an embodiment, as seen in FIG. 4, a listening node may wait in an idle state 400 until it receives a first frame 425, such as an IRTS frame, from a sending node. The listening node then enters a signaling state 430, where it may determine based on the service code within the first frame whether the listening node is a participating node or a non-participating node. If the listening node is a participating node, it transmits a second frame 435, such as an ICTS frame, to the sending node. The participating node is then free to begin receiving data 440. In an embodiment, the receiving node may transmit a third frame 445, such as an IACK frame, which may allow the sending node to determine path reliability.

If after receiving the first frame 425 the listening node determines based on the service code within the first frame that it is a non-participating node, then the listening node may enter a sleep state 450. This sleep state may be for any suitable duration, including the time required for any participating nodes to transmit the first frame (which may include the integrated service code), n(ICTS) frames, the piece of data, and n(IACK) frames. After the sleep duration is complete, the non-participating node may awake 460, and return to an idle state 400, wherein it may wait before attempting to send or receive its next transmission

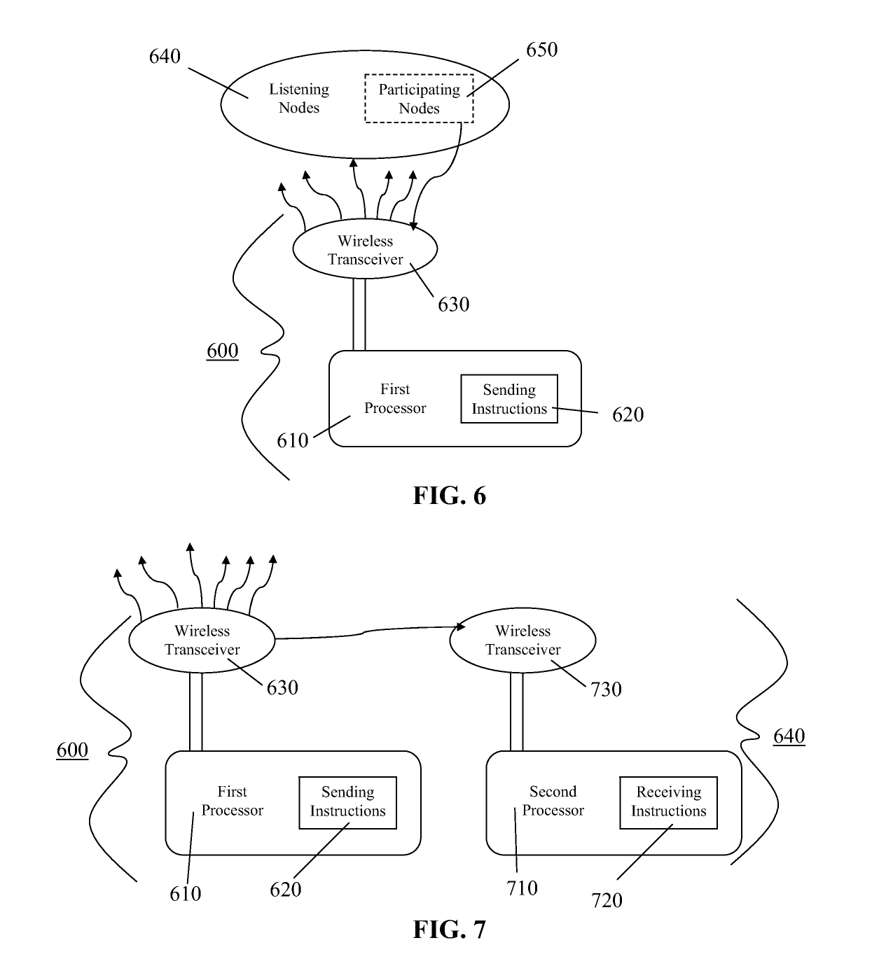

Turning now to FIG. 6, embodiments may also include a system for network communications containing a sending node 600. The sending node 600 may be of any suitable type, including but not limited to, a desktop computer, a laptop computer, a netbook, a handheld device, a smart-phone, and so on. The system contains at least one first processor 610. The first processor 610 may be of any suitable type or configuration, including but not limited to a computer processor, a network processor, a microprocessor, or an integrated circuit. The first processor 610 may be configured to execute sending instructions 620. The sending instructions 620 may comprise a step of generating a first frame with an integrated service code. The first frame can be any suitable type or configuration, including but not limited to an IRTS frame, depicted as IRTS frame 510 in FIG. 5. Returning to FIG. 6, the service code can be of any suitable type, including but not limited to a service code comprising a node identifier and a unique identification number for a service. Sending instructions 620 also may comprise transmitting the first frame from the sending node 600 to one or more listening nodes 640. The transmission process can be performed by any suitable means, including but not limited to via a transmitter-receiver, or as shown in the non-limiting embodiment in FIG. 6, via a wireless transceiver 630. Sending instructions 620 may further comprise determining if at least one or more listening nodes 640 are participating nodes 650. This may be accomplished by any suitable means, including but not limited to, receiving a second frame from the participating nodes 650. Sending instructions 620 may further comprise transmitting a piece of data from the sending node 600 to the participating nodes 650.

As depicted in FIG. 7, in some embodiments of the system comprising the sending node 600, at least one or more listening nodes 640 may comprise at least one second processor 710, which may be of any suitable type or configuration, including but not limited to a computer processor, a network processor, a microprocessor, and an integrated circuit. The second processor 710 may be configured to execute receiving instructions 720. The receiving instructions 720 may comprise a step of receiving the first frame. The first frame can be any suitable type or configuration, including but not limited to an IRTS frame, depicted as IRTS frame 510 in FIG. 5. Returning to FIG. 7, receiving instructions 720 may further comprise determining, based on the service code, if the listening node 640 is a participating node. If the listening node 640 is a participating node, receiving instructions 720 typically further comprise transmitting a second frame from the listening node 640 to the sending node 600. The second frame may be of any suitable type or configuration, including but not limited to an ICTS frame, depicted as ICTS frame 520 in FIG. 5.

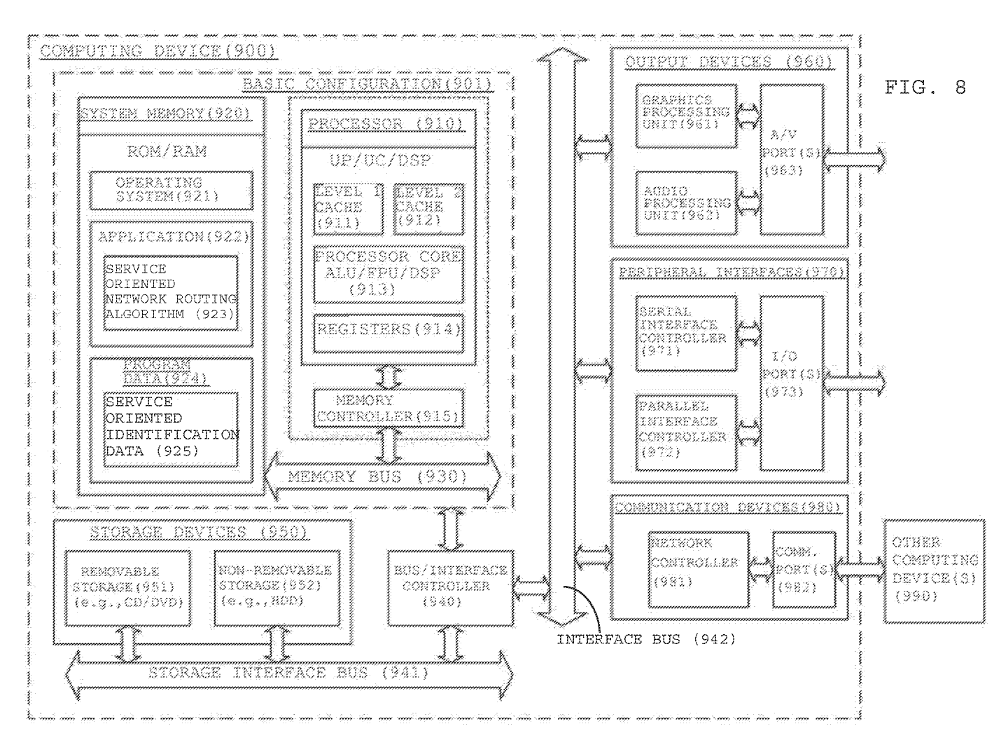

FIG. 8 is a block diagram illustrating an example computing device 900 that is arranged for service oriented ad-hoc wireless network communications in accordance with the present disclosure. In a very basic configuration 901, computing device 900 typically includes one or more processors 910 and a system memory 920. A memory bus 930 may be used for communicating between processor 910 and system memory 920.

Depending on the desired configuration, processor 910 may be of any type including but not limited to a microprocessor (μP), a microcontroller (μC), a digital signal processor (DSP), or any combination thereof. Processor 910 may include one more levels of caching, such as a level one cache 911 and a level two cache 912, a processor core 913, and registers 914. An example processor core 913 may include an arithmetic logic unit (ALU), a floating point unit (FPU), a digital signal processing core (DSP Core), or any combination thereof. An example memory controller 915 may also be used with processor 910, or in some implementations memory controller 915 may be an internal part of processor 910.

Depending on the desired configuration, system memory 920 may be of any type including but not limited to volatile memory (such as RAM), non-volatile memory (such as ROM, flash memory, etc.) or any combination thereof. System memory 920 may include an operating system 921, one or more applications 922, and program data 924. Application 922 may include a service oriented network routing algorithm 923 that is arranged to perform the functions as described herein including those described with respect to method 100 of FIG. 1, or method 200 of FIG. 2. Program data 924 may include service oriented identification data 925 that may be useful for determination if a listening node is a participation node, and to ensure communication reliability by matching the information conveyed in various frames, for example the ICTS frame and the IACK frame as is described herein (e.g. as shown in FIGS. 1-4). In some embodiments, application 922 may be arranged to operate with program data 924 on operating system 921 such that determinations of network participation based on the applicable service may be made as described herein. This described basic configuration 901 is illustrated in FIG. 8 by those components within the inner dashed line.

Computing device 900 may have additional features or functionality, and additional interfaces to facilitate communications between basic configuration 901 and any required devices and interfaces. For example, a bus/interface controller 940 may be used to facilitate communications between basic configuration 901 and one or more data storage devices 950 via a storage interface bus 941. Data storage devices 950 may be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 920, removable storage devices 951 and non-removable storage devices 952 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 942 for facilitating communication from various interface devices (e.g., output devices 960, peripheral interfaces 970, and communication devices 980) to basic configuration 901 via bus/interface controller 940. Example output devices 960 include a graphics processing unit 961 and an audio processing unit 962, which may be configured to communicate to various external devices such as a display or speakers via one or more A/V ports 963. Example peripheral interfaces 970 include a serial interface controller 971 or a parallel interface controller 972, which may be configured to communicate with external devices such as input devices (e.g., keyboard, mouse, pen, voice input device, touch input device, etc.) or other peripheral devices (e.g., printer, scanner, etc.) via one or more I/O ports 973. An example communication device 980 includes a network controller 981, which may be arranged to facilitate communications with one or more other computing devices 990 over a network communication link via one or more communication ports 982.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for routing information in a network comprising:
generating a first frame with an integrated service code;
transmitting the first frame from a sending node to one or more listening nodes;
determining if at least one of the one or more listening nodes have determined that they are participating nodes; and,
transmitting a piece of data from the sending node to the participating nodes.

2. The method of claim 1, wherein the service code comprises a node identifier and a unique identification number for a service.

3. The method of claim 1, wherein the first frame comprises a Request to Send frame.

4. The method of claim 1, wherein determining if at least one of the one or more listening nodes have determined that they are participating nodes comprises receiving at least one second frame from the participating nodes.

5. The method of claim 4, wherein the at least one second frame comprises a Clear to Send frame.

6. The method of claim 4, further comprising receiving a third frame from the participating nodes.

7. The method of claim 6, further comprising determining path reliability from the third frame.

8. The method of claim 7, wherein the third frame comprises an Acknowledgement frame.

9. A method for routing information on a network comprising:
receiving at one or more listening nodes a first frame comprising an integrated service code;
determining based on the integrated service code if the one or more listening nodes are participating nodes; and,
transmitting a second frame from the participating nodes.

10. The method of claim 9, wherein the second frame comprises a Clear to Send frame.

11. The method of claim 9, wherein the second frame comprises a Medium Access Control identifier for the participating nodes.

12. The method of claim 9, further comprising:
transmitting a third frame from the participating nodes to the sending node.

13. The method of claim 12, wherein the third frame comprises an Acknowledgement frame.

14. The method of claim 9, further comprising initiating a sleep mode on the listening nodes that are not participating nodes.

15. A system for network communications comprising:
at least one processor configured to execute sending instructions, the sending instructions comprising:
generating a first frame with an integrated service code;
transmitting the first frame from a sending node to one or more listening nodes;
determining if at least one of the one or more listening nodes have determined that they are participating nodes; and
transmitting a piece of data from the sending node to the participating nodes.

16. The system of claim 15, wherein the service code comprises a node identifier and a unique identification number for a service.

17. The system of claim 15, wherein the first frame comprises a Request to Send frame.

18. The system of claim 15, wherein the sending instructions further comprise receiving a second frame from the participating nodes.

19. The system of claim 15, wherein the sending instructions further comprise receiving a third frame from the participating nodes.

20. The system of claim 19, wherein the sending instructions further comprise determining path reliability from the third frame.

21. The system of claim 20, wherein the third frame comprises an Acknowledgement frame.

22. A system for network communications comprising:
at least one processor configured to execute receiving instructions, the receiving instructions comprising:
receiving at one or more listening nodes a first frame comprising an integrated service code;
determining based on the integrated service code if the one or more listening nodes are participating nodes; and,
transmitting a second frame from the participating nodes.

23. The system of claim 22, wherein the second frame comprises a Medium Access Control identifier for the participating nodes.

24. The system of claim 22, wherein the receiving instructions further comprise:
transmitting a third frame from the participating nodes to the sending node.

25. The system of claim 24, wherein the third frame comprises an Acknowledgement frame.

26. The system of claim 22, wherein the receiving instructions further comprise initiating a sleep mode on the listening nodes that are not participating nodes.
